(19) United States
(12) Patent Application Publication
(10) Pub. No.: US 2016/0197995 A1
(43) Pub. Date: Jul. 7, 2016

(54) PROVIDING STORAGE SERVICE TO TENANT IN CLOUD STORAGE ENVIRONMENT

(71) Applicant: EMC Corporation, Hopkinton, MA (US)

(72) Inventors: Patrick Minggang Lu, Shanghai (CN); Chao Chen, Shanghai (CN); Henry Haihua Chang, Shanghai (CN); Wenrey Wenlei Guo, Shanghai (CN); Sandro Jiawei Wu, Shanghai (CN)

(21) Appl. No.: 14/971,137

(22) Filed: Dec. 16, 2015

(30) Foreign Application Priority Data
Jan. 4, 2015 (CN) CN201510004937.0

(51) Int. Cl. H04L 29/08; G06F 9/455

(52) U.S. Cl. CPC H04L 67/1097; G06F 9/45533

(57) ABSTRACT

A method and apparatus for providing storage service to a tenant in a cloud storage environment. Specifically, in one embodiment of the present invention, there is provided a method for providing storage service to a tenant in a cloud storage environment, comprising: extracting from a request from the tenant a storage service requirement associated with the request; acquiring from the cloud storage environment at least one logical drive meeting the storage service requirement; building a virtual storage container associated with the at least one logical drive; and providing requested storage service to the tenant via the virtual storage container. In one embodiment of the present invention, there is provided an apparatus for providing storage service to a tenant in a cloud storage environment. By means of the method and apparatus of the present invention, customized storage service can be provided to tenants more efficiently.

### RELATED APPLICATIONS

This application claims priority from Chinese Patent Application Number CN201510004937.0 filed on Jan. 4, 2015 entitled “METHOD AND APPARATUS FOR PROVIDING STORAGE SERVICE TO A TENANT IN A CLOUD STORAGE ENVIRONMENT” the content and teachings of which is herein incorporated by reference in its entirety.

### FIELD

Various embodiments of the present invention relate to storage service, and more specifically, to a method and apparatus for providing storage service to a tenant in a cloud storage environment.

### BACKGROUND

With the development of data storage technology, various data storage devices now provide an increasingly higher data storage capacity, with a huge improvement on data access speed. In addition, the development of network technology has opened up a new direction for data storage; a data storage device is no longer limited to be locally deployed at an access device, but may be disposed at any physical position that is accessible via a network.

So far there has been proposed a technical solution for providing a data storage service to massive tenants by a cloud storage environment. In this technical solution, the cloud storage environment may comprise multiple storage devices that are distributed across multiple physical positions. For a tenant under the cloud storage environment, the user may not care about the physical position of a storage device being accessed currently, but can execute data read/write operations simply by accessing logical storage which the cloud storage environment presents to the outside.

In a conventional data storage system, a user may directly specify the Quality of Service (QoS) level which a storage device should have, buy and configure a physical storage device to meet the QoS level. Unlike the conventional centralized data storage system, in the cloud storage environment, what is accessed by a tenant is a virtual storage space. Since the virtual storage space may be distributed across multiple physical storage devices at multiple geographic positions, a couple of problems may arise when specifying the QoS level of the virtual storage space.

On the other hand, since different tenants have miscellaneous requirements for the QoS level (for example, some tenants want to get faster response speed, while others may tolerate slow response speed), it is now a burning problem regarding how to conveniently and flexibly provide storage service that meets the specified QoS level to tenants in the cloud storage environment.

### SUMMARY

Therefore, it is desirable to develop and implement a technical solution that can conveniently and flexibly provide specified QoS level to tenants in a cloud storage environment. It is desired the technical solution can provide storage service meeting a storage service requirement according to the tenant's requirement in view of intrinsic characteristics of the cloud storage environment.

In one embodiment of the present invention, there is provided a method for providing storage service to a tenant in a cloud storage environment, comprising: extracting from a request from the tenant a storage service requirement associated with the request; acquiring from the cloud storage environment at least one logical drive meeting the storage service requirement; building a virtual storage container associated with the at least one logical drive; and providing requested storage service to the tenant via the virtual storage container.

In one embodiment of the present invention, there is provided an apparatus for providing storage service to a tenant in a cloud storage environment, comprising: an extracting module configured to extract from a request from the tenant a storage service requirement associated with the request; an acquiring unit configured to acquire from the cloud storage environment at least one logical drive meeting the storage service requirement; a building module configured to build a virtual storage container associated with the at least one logical drive; and a providing module configured to provide requested storage service to the tenant via the virtual storage container.

The method and apparatus according to various embodiments of the present invention may be implemented without changing existing configuration of the cloud storage environment as far as possible. Specifically, in the embodiments of the present invention, logical drives meeting a storage service requirement from a tenant are looked up in the cloud storage environment, and a virtual storage container is built based on the logical drives so as to provide storage service to the tenant via the virtual storage container. Thereby, the virtual storage container may act as an agent of storage service and is used for providing storage service meeting different storage service requirements to various tenants.

### BRIEF DESCRIPTION OF THE SEVERAL VIEWS OF THE DRAWINGS

Through the more detailed description in the accompanying drawings, the above and other objects, features and advantages of the embodiments of the present invention will become more apparent. Several embodiments of the present invention are illustrated schematically and are not intended to limit the present invention. In the drawings:

FIG. 1 schematically illustrates a block diagram of an exemplary computer system which is applicable to implement the embodiments of the present invention;

FIG. 2 schematically illustrates a block diagram of a technical solution for providing storage service to a tenant according to one technical solution;

FIG. 3 schematically illustrates a block diagram of a technical solution for providing storage service to a tenant in a cloud storage environment according to one embodiment of the present invention;

FIG. 4 schematically illustrates a flowchart of a method for providing storage service to a tenant in a cloud storage environment according to one embodiment of the present invention;

FIG. 5 schematically illustrates a block diagram of access speeds of logical drives in the cloud storage environment according to one embodiment of the present invention;

FIG. 6 schematically illustrates a block diagram of a virtual storage container according to one embodiment of the present invention; and

FIG. 7 schematically illustrates a block diagram of an apparatus for providing storage service to a tenant in a cloud storage environment according to one embodiment of the present invention.

### DETAILED DESCRIPTION

Some preferable embodiments will be described in more detail with reference to the accompanying drawings, in which the preferable embodiments of the present disclosure have been illustrated. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure to those skilled in the art.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-requirement network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-requirement self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to requirement. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

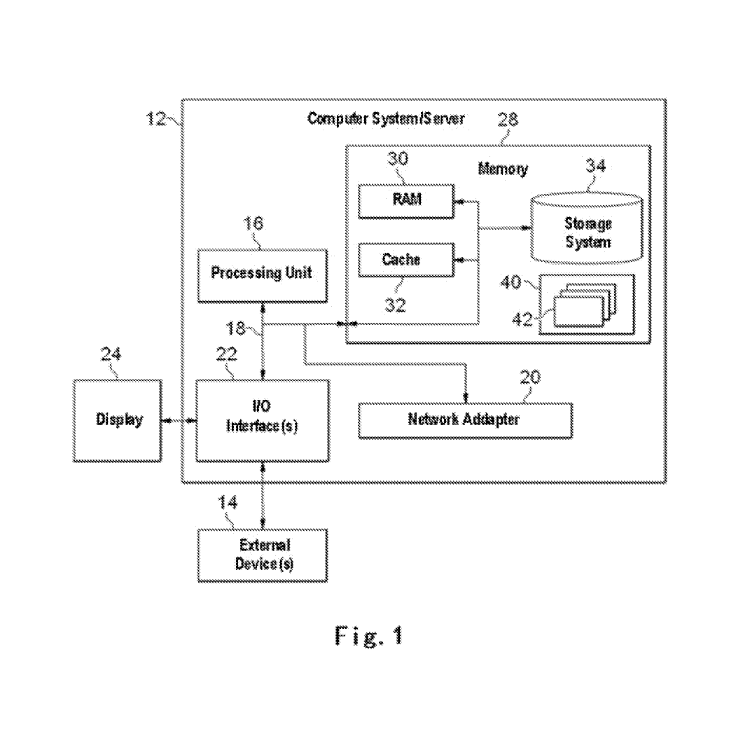

FIG. 1 illustrates an exemplary computer system 100 which is applicable to implement the embodiments of the present invention. As illustrated in FIG. 1, the computer system 100 may include: CPU (Central Process Unit) 101, RAM (Random Access Memory) 102, ROM (Read Only Memory) 103, System Bus 104, Hard Drive Controller 105, Keyboard Controller 106, Serial Interface Controller 107, Parallel Interface Controller 108, Display Controller 109, Hard Drive 110, Keyboard 111, Serial Peripheral Equipment 112, Parallel Peripheral Equipment 113 and Display 114. Among above devices, CPU 101, RAM 102, ROM 103, Hard Drive Controller 105, Keyboard Controller 106, Serial Interface Controller 107, Parallel Interface Controller 108 and Display Controller 109 are coupled to the System Bus 104. Hard Drive 110 is coupled to Hard Drive Controller 105. Keyboard 111 is coupled to Keyboard Controller 106. Serial Peripheral Equipment 112 is coupled to Serial Interface Controller 107. Parallel Peripheral Equipment 113 is coupled to Parallel Interface Controller 108. And, Display 114 is coupled to Display Controller 109. It should be understood that the structure as illustrated in FIG. 1 is only for the exemplary purpose rather than any limitation to the present invention. In some cases, some devices may be added to or removed from the computer system 100 based on specific situations.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or one embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Those skilled in the art should understand that a typical example of the application environment in which the embodiments of the present invention may be implemented has been depicted for illustration only. In the context of the present invention, the embodiments of the present invention may be implemented in various application environments that are already known or to be developed later.

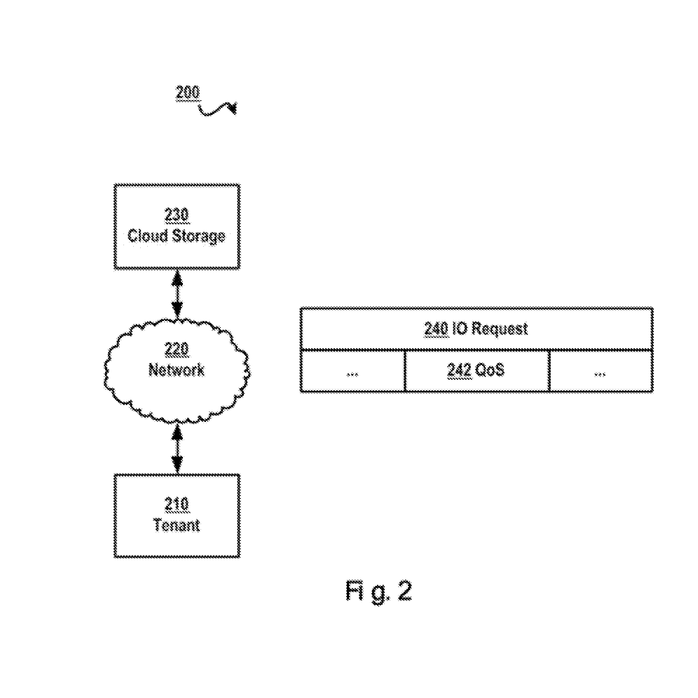

FIG. 2 schematically shows a block diagram 200 of a technical solution for providing storage service to a tenant according to one technical solution. As shown in FIG. 2, in the cloud storage environment, a tenant 210 accesses cloud storage 230 via a network 220. Note although cloud storage 230 is shown in one block in FIG. 2, it may actually be distributed across different physical storage devices at different geographic positions.

Note the provider of the cloud storage environment may deploy storage devices at multiple geographic positions, and tenant 210 can use a storage space in the cloud storage environment and utilize storage service provided by the storage service provider. When tenant 210 performs read/write operations to cloud storage 230, he/she does not have to know the internal topological structure of the cloud storage environment.

As indicated by arrows in FIG. 2, tenant 210 sends an IO request to cloud storage 230 via network 220, and cloud storage 230 responds to the request. In this technical solution, when tenant 210 needs to specify a specific QoS level, for example, specify Input/Output Operation Per Second (IOPS), a special tag may be added to an IO request 240 to specify the QoS level.

After receiving IO request 240 from the tenant, the provider of cloud storage 230 needs to parse the tenant desired QoS level according to the tag in IO request 240. In this technical solution, the provider of cloud storage 230 has to parse the tag in IO request 240 every time the IO request 240 is received. If there are numerous tenants submitting IO requests frequently, the provider of cloud storage 230 will spend huge time and consume various computing resources.

In view of the above drawbacks in the existing technical solution, the present invention provides a method for providing storage service to a tenant in a cloud storage environment, comprising: extracting from a request from the tenant a storage service requirement associated with the request; acquiring from the cloud storage environment at least one logical drive meeting the storage service requirement; building a virtual storage container associated with the at least one logical drive; and providing requested storage service to the tenant via the virtual storage container.

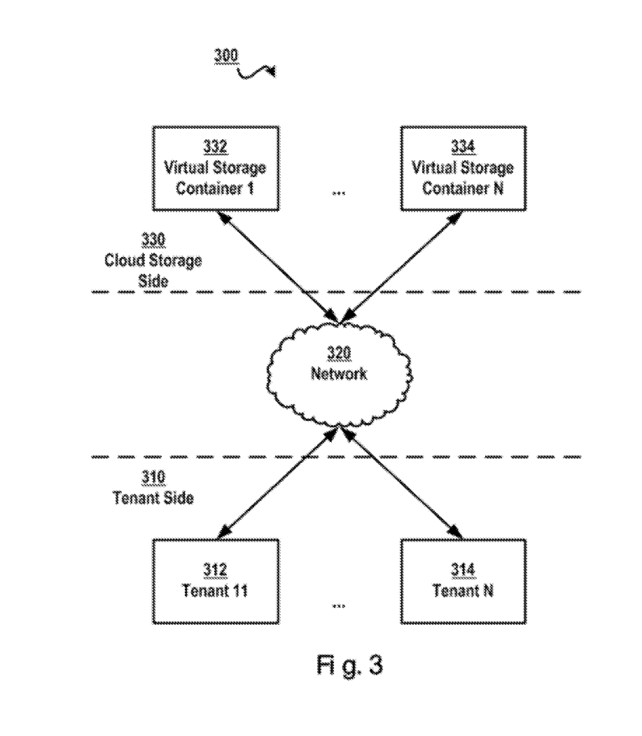

Specifically, FIG. 3 schematically shows a block diagram 300 of a technical solution for providing storage service to a tenant in a cloud storage environment according to one embodiment of the present invention. As shown in this figure, in the embodiment of the present invention, when various tenants make requests for a storage space to the provider of cloud storage, a related storage service requirement may be extracted from a corresponding tenant's request, and a virtual storage container may be built for each tenant based on the storage service requirement.

As shown in FIG. 3, a tenant 1 312 at tenant side 310 may access storage resources at cloud storage side 330 via a network 320, specifically, storage service may be provided to tenant 1 312 via a virtual storage container 1 332; a tenant N 314 at tenant side 310 may access storage resources at cloud storage side 330 via network 320, specifically, storage service may be provided to tenant N 314 via a virtual storage container N 334.

In the embodiment of the present invention, initially when the tenant makes a request for storage service to the cloud storage environment, the tenant's storage service requirement is taken into consideration, a virtual storage container is built based on the storage service requirement, and subsequently storage service is provided to the corresponding tenant via the virtual storage container. Thereby, the provider of the cloud storage environment does not have to pass every request from each tenant one after another, thereby greatly reducing various resource overheads for the provider of the cloud storage environment.

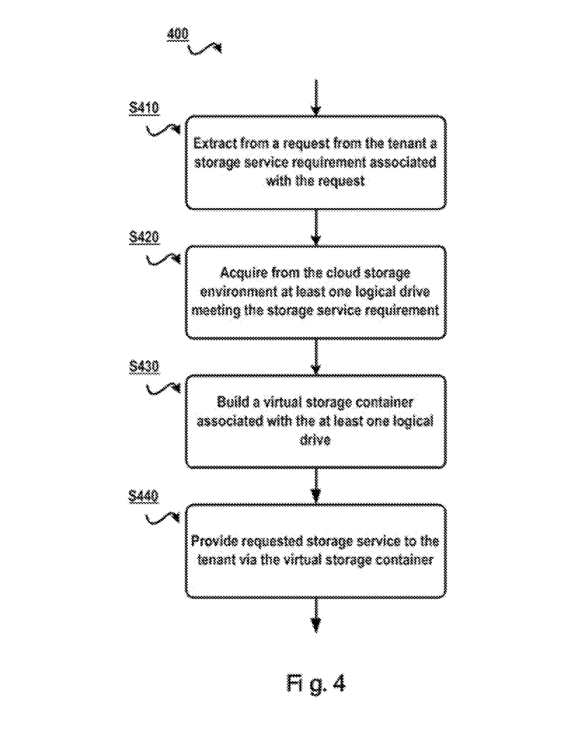

FIG. 4 schematically shows a flowchart 400 of a method for providing storage service to a tenant in a cloud storage environment according to one embodiment of the present invention. Specifically, in step S410, a storage service requirement associated with a request from the tenant is extracted from the request. The request from the tenant may take a variety of forms. For example, when the tenant wants MySQL instances to be provided in the cloud storage environment, the request at this point may be a request on MySQL. In the context of the present invention, the tenant may further request instances of other applications, such as Web Server instances, Hadoop instances, etc.

In step S420, at least one logical drive meeting the storage service requirement is acquired from the cloud storage environment. Those skilled in the art should understand that in the cloud storage environment, a physical storage device is presented to tenants as a logical drive; thereby, in this step one or more logical drives that meet the storage service requirement may be looked up in the cloud storage environment. For example, when the user requests a smaller storage space, storage service may be provided to the tenant by one logical drive; when the user requests a larger storage space, storage service may be provided to the tenant by multiple logical drives.

There may further exist such a circumstance that the tenant makes multiple storage service requirements at different levels, at which point multiple logical drives respectively provide storage service that meets different levels of storage service requirements.

In step S430, a virtual storage container associated with the at least one logical drive is built. In the embodiment of the present invention, the virtual storage container acts as an interface via which the cloud storage environment provides storage service to the tenant. That is, the virtual storage container receives IO requests from the tenant, executes these IO requests and returns responses to the tenant.

In step S440, requested storage service is provided to the tenant via the virtual storage container. Thereby, the provider of the cloud storage environment does not have to parse tags related to QoS from every IO request of the tenant one by one, thereby saving large time and computing resources.

By means of the above embodiment of the present invention, logical drives meeting the storage service requirement of the tenant are looked up in the cloud storage environment, and a virtual storage container is built based on the logical drives so as to provide storage service to the tenant. In this manner, the virtual storage container may act as an agent of storage service and further provide to various tenants storage service that meets different storage service requirements.

In one embodiment of the present invention, the logical drive is a Logical Unit Number. The logical drive may be presented as a Logical Unit Number (LUN). Specifically, suppose in the user's client device there exist physical storages “Drive C:” and “Drive D:”, and the logical drive may be separately presented in the form of “Drive F:”. At this point, simply by clicking on the “Drive F:”, storage service provided by the cloud storage environment can be utilized. The LUN system may be a high performance file sharing and storage device, and tenants may execute read/write operations via the network. In the cloud storage environment, the storage space accessed by tenants may be various geographic positions distributed in the cloud storage environment, and tenants do not need to care about concrete geographic positions of physical storage devices being accessed.

Throughout the context of the present invention, storage service may be provided to the tenant via the virtual storage container, at which point the tenant can access a storage space in the cloud storage environment by the Logical Unit Number. Description is presented by taking a LUN as a concrete example of the logical drive.

In one embodiment of the present invention, the acquiring from the cloud storage environment at least one logical drive meeting the storage service requirement comprises: obtaining a QoS requirement associated with the storage service requirement; and searching a configuration list that includes QoS provided by various logical drives in the cloud storage environment, so as to find at least one logical drive matching the QoS requirement.

In this embodiment, the configuration list may comprise QoS provided by various logical drives in the cloud storage environment. At least one logical drive matching the tenant desired QoS requirement can be found by searching the configuration list. Those skilled in the art may customize a data structure of the configuration list, for example, may use an example as shown by Table 1 below.

TABLE 1
Example of Configuration List

| No. | Logical Drive ID | Capacity | Access Speed (IOPS) |
|---|---|---|---|
| 1 | LUN1 | 2 T | 3000 |
| 2 | LUN2 | 5 T | 5000 |
| . . . | . . . | | |

In the example of Table 1, the configuration list is shown by taking access speed as a concrete example of the QoS requirement. The second column in Table 1 represents ID of a logical drive, the third column represents a capacity of the logical drive, and the fourth column represents access speed which the logical drive can provide. For example, when it is found that the tenant desires to obtain access speed of 3000 IOPS, the logical drive LUN1 is a logical drive matching the QoS requirement; when the tenant desires to obtain higher access speed, the logical drive LUN2 may be assigned to the tenant.

Those skilled in the art should understand when different users request instances of different applications, these instances of different applications have different requirements for storage service. Specifically, suppose the MySQL instance has a faster access speed than the Web Server instance; then a storage service requirement associated with a request for the MySQL instance may be higher than a storage service requirement associated with a request for the Web Server instance.

In addition, those skilled in the art may further define the level of storage service requirements at finer granularity. For example, regarding requests for MySQL instances, a tenant 1 wants to serve 10000 users while a tenant 2 wants to serve 100 users, at which point a storage service requirement associated with the request of tenant 1 may be higher than a storage service requirement associated with the request of tenant 2.

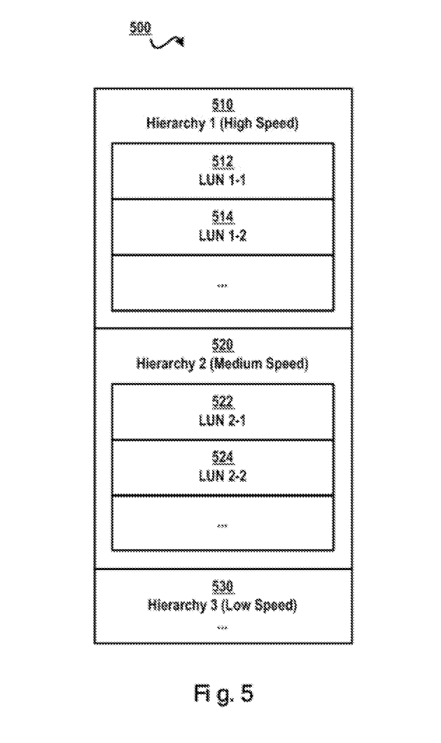

FIG. 5 schematically shows a block diagram 500 of access speeds of logical drives in the cloud storage environment according to one embodiment of the present invention. As shown in this figure, the cloud storage environment may comprise storage media with different access speeds. For example, a hierarchy 1 510 shows high speed storage media, for example, may include a LUN 1-1 512, a LUN 1-2 514, etc.; a hierarchy 2 520 shows medium speed storage media, for example, may include a LUN 2-1 522, a LUN 2-2 524, etc. In this embodiment, a logical drive with matched access speed may be selected from logical drives as shown in FIG. 5 according to the tenant's storage service requirement.

In one embodiment of the present invention, the QoS requirement comprises at least one of: access speed, and response time. Although the QoS requirement is shown by means of access speed in Table 1 above, those skilled in the art may further use response time or other metrics to measure the level of the QoS requirement.

In one embodiment of the present invention, the configuration list further records application containers for managing various logical drives in the cloud storage environment; and the building a virtual storage container associated with the at least one logical drive comprises: associating the virtual storage container with the application container.

In this embodiment, various logical drives in the cloud storage environment may be managed using application containers. Specifically, the application container may be used for managing various operations associated with the logical drive, for example, may manage various read/write operations to the logical drive. In this embodiment, an example of the configuration list may be as shown in Table 2 below.

TABLE 2
Example of Configuration List

| | Logical | | Access Speed | |
|---|---|---|---|---|
| No. | Drive ID | Capacity | (IOPS) | Application Container |
| 1 | LUN1 | 2 T | 3000 | application container |
| | | | | instance 1 |
| 2 | LUN2 | 3 T | 5000 | application container |
| | | | | instance 2 |
| . . . | . . . | . . . | . . . | . . . |

In this embodiment, when it is found the user wants to obtain an access speed of 3000 IOPS, the logical drive LUN1 may be assigned to the tenant, and at this point the building a virtual storage container associated with the at least one logical drive comprises: associating the virtual storage container with the application container. Specifically, the application container instance 1 may be added to the virtual storage container, so that the application container instance 1 is responsible for handing IO requests received from the tenant.

In one embodiment of the present invention, the providing requested storage service to the tenant via the virtual storage container comprises: providing the requested storage service to the tenant via the application container associated with the virtual storage container. Continuing the foregoing example, in this embodiment storage service may be provided to the tenant via the application container instance 1.

In the existing technical solution of cloud storage environment, when the tenant makes a request for a cloud storage space to the cloud storage environment, the provider of the cloud storage environment may allocate to the user the cloud storage space of a desired size and start for the tenant various data services supported by the cloud storage environment. Since different tenants have different focuses of attention, they need different data services. However, the existing technical solution does not differentiate which services are necessary to tenants, but starts various supported data services.

To start data services in the cloud storage environment that might be undesired by tenants will occupy large resources of the cloud storage environment and reduce response speed of the cloud storage environment. Therefore, it is desirable to, before starting data services, first determine which type of data service is needed by a tenant and then start the desired type of data service only.

In one embodiment of the present invention, there is further comprised: acquiring a service type requirement from the tenant, the service type requirement describing the type of data service which the tenant wants to start in the storage service; and the providing requested storage service to the tenant via the virtual storage container comprises: providing the type of data service to the tenant via the virtual storage container.

In this embodiment, the tenant's service type requirement may be acquired by all means. For example, an additional field describing the service type requirement may be set in an initial request from the tenant, or additional description of the service type requirement may be received from the tenant. In the context of the present invention, it is not intended to limit how to acquire the service type requirement. In subsequent operation steps, only this type of data service is provided to the tenant, rather than starting other types of data service.

In one embodiment of the present invention, the configuration list further comprises data service containers for managing types of data service provided to the tenant; and the building a virtual storage container associated with the at least one logical drive comprises: associating the virtual storage container with the data service container.

In this embodiment, the data service container is for managing types of data service provided to the tenant. Table 3 schematically shows an example of the configuration list, wherein the data service container column shows instances of data service containers associated with various logical drives.

TABLE 3
Example of Configuration List

| | Logical | | | | |
|---|---|---|---|---|---|
| | Drive | | Access Speed | Application | Data Service |
| No. | ID | Capacity | (IOPS) | Container | Container |
| 1 | LUN1 | 2 T | 3000 | application | data service |
| | | | | container | container |
| | | | | instance 1 | instance 1 |
| 2 | LUN2 | 5 T | 5000 | application | data service |
| | | | | container | container |
| | | | | instance 1 | instance 2 |
| . . . | . . . | . . . | . . . | . . . | . . . |

In one embodiment of the present invention, the providing requested storage service to the tenant via the virtual storage container comprises: providing the type of data service to the tenant via the data service container associated with the virtual storage container. Specifically, continuing the example of Table 3, when the tenant requests a logical drive having access speed of 3000 IOPS, LUN1 may be assigned to the tenant, the virtual storage container is associated with the application container instance 1 and the data service container instance 1, and these two container instances provides data service to the tenant.

In one embodiment of the present invention, type of the data service comprises at least one of: de-duplication, replication, FAST VP and FAST Cache.

In the context of the present invention, those skilled in the art may understand that de-duplication is an important way to increase the effective storage capacity. The de-duplication technique helps tenants to reduce the consumption of storage space in the cloud storage environment. Generally, replication means making a copy of data, and FAST VP and FAST Cache are two data services for improving the storage performance, by which tenants may specify, according to their own requirements, which data service or services are to be used.

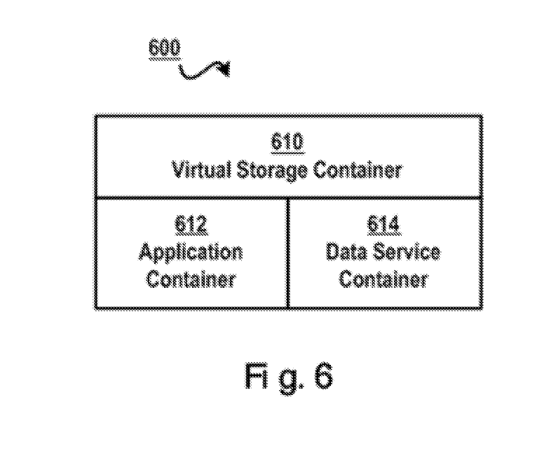

FIG. 6 schematically shows a block diagram 600 of a virtual storage container according to one embodiment of the present invention. As shown in FIG. 6, a virtual storage container 610 may be associated with an application container 612 and a data service container 614 respectively. Specifically, application container 612 is for controlling requested storage service provided to the tenant, and data service container 614 is for managing a type of data service provided to the tenant. Specifically, if the tenant requests a MySQL application instance and wants to start the data service of de-duplication, then application container 612 can manage and run the MySQL application instance, and data service container 614 can manage and run an instance of the de-duplication data service.

In one embodiment of the present invention, the providing requested storage service to the tenant via the virtual storage container comprises: in response to receiving an IO request, providing storage service associated with the IO request. Specifically, when the IO request is a read request, requested data may be acquired from a virtual storage space in the cloud storage environment; when the IO request is a write request, specified data may be written to a virtual storage space in the cloud storage environment.

By means of the method of the present invention, the provider of the cloud storage environment, when initially allocating a cloud storage space to the tenant, only needs to build a related virtual storage container based on the storage service requirement, and the virtual storage container is responsible for handling various IO requests from the tenant. At this point, the tenant's QoS requirement is applicable to all IO requests from the tenant, so the provider of the cloud storage environment does not have to parse each IO request from the tenant one by one. Therefore, time and resource overheads can be reduced greatly.

Those skilled in the art should understand in the context of the present invention, the “container” is a logical concept, and a container may be implemented in various running environments which are applicable to run the container. Specifically, various containers involved in the present invention may be implemented on a physical machine and/or virtual machine.

Various embodiments implementing the method of the present invention have been described above with reference to the accompanying drawings. Those skilled in the art may understand that the method may be implemented in software, hardware or a combination of software and hardware. Moreover, those skilled in the art may understand by implementing steps in the above method in software, hardware or a combination of software and hardware, there may be provided an apparatus based on the same invention concept. Even if the apparatus has the same hardware structure as a general-purpose processing device, the functionality of software contained therein makes the apparatus manifest distinguishing properties from the general-purpose processing device, thereby forming an apparatus of the various embodiments of the present invention. The apparatus described in the present invention comprises several means or modules, the means or modules configured to execute corresponding steps. Upon reading this specification, those skilled in the art may understand how to write a program for implementing actions performed by these means or modules. Since the apparatus is based on the same invention concept as the method, the same or corresponding implementation details are also applicable to means or modules corresponding to the method. As detailed and complete description has been presented above, the apparatus is not detailed below.

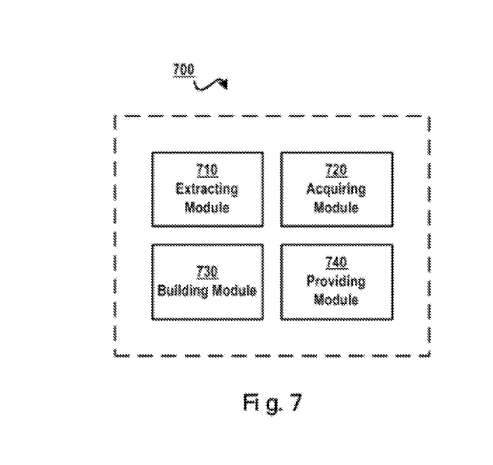

FIG. 7 schematically shows a block diagram 700 of an apparatus for providing storage service to a tenant in a cloud storage environment. As shown in FIG. 7, there is provided an apparatus for providing storage service to a tenant in a cloud storage environment, comprising: an extracting module 710 configured to extract from a request from the tenant a storage service requirement associated with the request; an acquiring unit 720 configured to acquire from the cloud storage environment at least one logical drive meeting the storage service requirement; a building module 730 configured to build a virtual storage container associated with the at least one logical drive; and a providing module 740 configured to provide requested storage service to the tenant via the virtual storage container.

In one embodiment of the present invention, acquiring module 720 comprises: an obtaining module configured to obtain a QoS requirement associated with the storage service requirement; and a searching module configured to search a configuration list that includes the Quality of Service provided by various logical drives in the cloud storage environment, so as to find at least one logical drive matching the QoS requirement.

In one embodiment of the present invention, the configuration list further records application containers for managing various logical drives in the cloud storage environment; and the building module 730 is further configured to associate the virtual storage container with the application container.

In one embodiment of the present invention, the providing module 740 is further configured to provide the requested storage service to the tenant via the application container associated with the virtual storage container.

In one embodiment of the present invention, the QoS requirement comprises at least one of: access speed, and response time.

In one embodiment of the present invention, there are further comprised: a type acquiring module configured to acquire a service type requirement from the tenant, the service type requirement describing type of data service which the tenant wants to start in the storage service; and the providing module 740 is further configured to provide the type of data service to the tenant via the virtual storage container.

In one embodiment of the present invention, the configuration list further records data service containers for managing types of data service provided to the tenant; and the building module 730 is further configured to associate the virtual storage container with the data service container.

In one embodiment of the present invention, the providing module 740 is further configured to provide the type of data service to the tenant via the data service container associated with the virtual storage container.

In one embodiment of the present invention, type of the data service comprises at least one of: de-duplication, replication, FAST VP and FAST Cache.

In one embodiment of the present invention, the logical drive is a Logical Unit Number.

The method and apparatus according to various embodiments of the present invention may be implemented without changing existing configuration of the cloud storage environment as far as possible. In addition, by means of the method and apparatus of the present invention, a virtual storage container may be built initially when receiving a request from the tenant, and the virtual storage container provides subsequent storage service to the tenant without parsing every IO request from the tenant one by one.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks illustrated in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for providing storage service to a tenant in a cloud storage environment, comprising:
extracting from a request from the tenant a storage service requirement associated with the request;
acquiring from the cloud storage environment at least one logical drive meeting the storage service requirement;
building a virtual storage container associated with the at least one logical drive; and
providing requested storage service to the tenant via the virtual storage container.

2. The method according to claim 1, wherein the acquiring from the cloud storage environment at least one logical drive meeting the storage service requirement comprises:
obtaining a QoS requirement associated with the storage service requirement; and
searching a configuration list that includes QoS provided by various logical drives in the cloud storage environment, so as to find at least one logical drive matching the QoS requirement.

3. The method according to claim 2, wherein the configuration list further records application containers for managing various logical drives in the cloud storage environment; and
the building a virtual storage container associated with the at least one logical drive comprises: associating the virtual storage container with the application container.

4. The method according to claim 3, wherein the providing requested storage service to the tenant via the virtual storage container comprises:
providing the requested storage service to the tenant via the application container associated with the virtual storage container.

5. The method according to any of claims 1 to 4, wherein the QoS requirement comprises at least one of: access speed, and response time.

6. The method according to any of claims 1 to 4, further comprising:
acquiring a service type requirement from the tenant, the service type requirement describing a type of data service which the tenant wants to start in the storage service; and
the providing requested storage service to the tenant via the virtual storage container comprises: providing the type of data service to the tenant via the virtual storage container.

7. The method according to claim 6, wherein the configuration list further records data service containers for managing types of data service provided to the tenant; and
the building a virtual storage container associated with the at least one logical drive comprises: associating the virtual storage container with the data service container.

8. The method according to claim 7, wherein the providing requested storage service to the tenant via the virtual storage container comprises: providing the type of data service to the tenant via the data service container associated with the virtual storage container.

9. The method according to claim 6, wherein the type of the data service comprises at least one of: de-duplication, replication, FAST VP and FAST Cache.

10. The method according to any of claims 1 to 4, wherein the logical drive is a Logical Unit Number.

11. An apparatus for providing storage service to a tenant in a cloud storage environment, comprising:
an extracting module configured to extract from a request from the tenant a storage service requirement associated with the request;
an acquiring module configured to acquire from the cloud storage environment at least one logical drive meeting the storage service requirement;
a building module configured to build a virtual storage container associated with the at least one logical drive; and
a providing module configured to provide requested storage service to the tenant via the virtual storage container.

12. The apparatus according to claim 11, wherein the acquiring module comprises:
an obtaining module configured to obtain a QoS requirement associated with the storage service requirement; and
a searching module configured to search a configuration list that includes QoS provided by various logical drives in the cloud storage environment, so as to find at least one logical drive matching the QoS requirement.

13. The apparatus according to claim 12, wherein the configuration list further records application containers for managing various logical drives in the cloud storage environment; and
the building module is further configured to associate the virtual storage container with the application container.

14. The apparatus according to claim 13, wherein the providing module is further configured to provide the requested storage service to the tenant via the application container associated with the virtual storage container.

15. The apparatus according to any of claims 11 to 14, wherein the QoS requirement comprises at least one of: access speed, and response time.

16. The apparatus according to any of claims 11 to 14, further comprising:
a type acquiring module configured to acquire a service type requirement from the tenant, the service type requirement describing a type of data service which the tenant wants to start in the storage service; and
the providing module is further configured to provide the type of data service to the tenant via the virtual storage container.

17. The apparatus according to claim 16, wherein the configuration list further records data service containers for managing types of data service provided to the tenant; and
the building module is further configured to associate the virtual storage container with the data service container.

18. The apparatus according to claim 17, wherein the providing module is further configured to provide the type of data service to the tenant via the data service container associated with the virtual storage container.

19. The apparatus according to claim 16, wherein type of the data service comprises at least one of: de-duplication, replication, FAST VP and FAST Cache.
